(19) United States
(12) Patent Application Publication
(10) Pub. No.: US 2010/0081636 A1
(43) Pub. Date: Apr. 1, 2010

(54) METHOD FOR THE NEMATOCIDAL TREATMENT OF PLANTS USING EUGENOL AND/OR LECITHIN(S) AND/OR DERIVATIVES THEREOF

(76) Inventor: Alberto Sardo, Chateaurenard (FR)

Correspondence Address: WENDEROTH, LIND & PONACK, L.L.P., 1030 15th Street, N.W.,, Suite 400 East, Washington, DC, 20005-1503, US

(21) Appl. No.: 12/450,511

(22) PCT Filed: Feb. 14, 2008
(86) PCT No.: PCT/FR2008/050247

§ 371 Date: Oct. 16, 2009

(30) Foreign Application Priority Data
Mar. 30, 2007 (FR) 07 54164

(51) Int. Cl. A01N 57/12; A01P 5/00

(52) U.S. Cl. 514/114

(57) ABSTRACT

The invention relates to a method for the nematocidal treatment of horticulture plants, that comprises applying a composition containing a combination of lecithin(s) and/or derivative(s) thereof and of one or more terpenes or salts thereof acceptable in the food industry, or a mixture thereof.

The present invention relates to a method for the nematocidal treatment of plants, such as horticultural plants, especially fruits or vegetables.

The phytoparasitic nematodes belong to two orders, the Dorylaimida and the Tylenchida. A distinction is made between:
root nematodes—in which the whole of the cycle takes place in the soil, some being mobile at all stages, external parasites (Tylenchus) or internal parasites (Pratylenchus), others being sedentary: cyst nematodes (Heterodera, Globodera);
root-knot nematodes (Meloidogyne, etc.);
nematodes of the aerial parts (Ditylenchus, Aphelenchoides).

Plant-parasitic nematodes have, in the anterior part of the digestive tract, a piercing stylet followed by an oesophageal tract terminating in a muscular bulb, which acts as a suction and pressure pump. Once the plant has been punctured by the stylet, digestive enzymes produced by the salivary glands are injected into the plant by the pump, which then sucks up the digested product and discharges it into the intestine.

Direct damage is above all a weakening of the plant, and sometimes distortion, discolouration, galls, etc; indirect damage consists in a worsening of fungal and viral diseases.

Galls denote abnormal tumours, outgrowths, bushing, etc. of plants, produced in response to the puncture or to the installation of said nematode (called the cecidogen) inside their tissues. Galls can affect all the organs of the plant. With the exception of particular cases (where galls are desirable products), their presence affects the vigour and yield of the crop. In Europe, the main cecidogenic insects are the gall midge, weevils, aphids, phylloxera, mites, phytopes and especially root-knot nematodes (Meloidogyne spp.). The latter are dangerous for a very large number of crops.

The male is filiform while the female, which is globular, measures about 0.5 mm in diameter. The four most widespread species are M. arenaria, M. incognita, M. javanica, M. hapta, the latter being adapted to colder climates. One particular species, M. naasi, has a narrower host range and attacks cereals in particular.

The Meloidogyne, which are very polyphagous, are dangerous pests which attack all crops. The most sensitive crops are the Solanaceae (tomato, aubergine, potato), the Cucurbitaceae (melon, cucumber), the Leguminosae (bean), carrot, scorzonera, lettuce, endive, artichoke, beet, celery, etc.

On leaving the egg, the larva moves in the film of water which covers the soil particles and makes its way to the young roots. It punctures the cell wall with its stylet, enters the root, makes its way towards the conducting vessels and induces the formation of giant cells, which are necessary for its growth. This results in the appearance of characteristic gall, which soon envelopes it completely and obstructs the sap-conducting vessels. After several moults, the lava transforms into a male or female. The male is released outside the root. The female, which is immobile, remains in the tissues and lays 1000 to 2000 eggs surrounded by a jelly-like substance which keeps them together. These egg masses protrude from the surface of the young roots.

Several generations can succeed one another in favourable conditions, and the infestation then reaches considerable proportions. In addition, the eggs are resistant to cold and to drought.

In the case of a very heavy attack, and on some sensitive plants (cucumber), the galls can become very voluminous and invade the entire root system, which is then reduced to a swollen stump with no hairs at all. The tubers become forked or warty. The aerial part may have reduced growth accompanied by a yellowing of the leaves. Infested plants are very sensitive to drought.

In addition, the presence of Meloidogyne favours or worsens attacks by fungi such as Fusarium or Verticillium albo-atrum which, from the soil, are able to invade the conducting vessels of the whole plant.

However, the chemical treatments which are conventionally used on the fruits or vegetables exhibit phytotoxicity in respect of the treated plants and are not harmless for the consumer. It is therefore particularly desirable to provide a method of preventing or eradicating nematodes of plants, especially fruits and vegetables. The treatment must therefore be harmless to the treated plant, nutritionally acceptable and simple and economical to carry out.

Lecithins are mixtures of combinations of esters of oleic, stearic, palmitic acid with glycerophosphoric acid and choline.

Lecithins are surfactants and emulsifying agents of natural origin, which are commonly used. Lecithins are widely used as additives in foods, pharmaceuticals or cosmetics. Nevertheless, their activity, especially nematocidal activity, has never been suggested.

The applicant has now developed a novel treatment based on a combination of terpene(s) and lecithin(s).

Surprisingly, it has now been found, according to the present invention, that lecithins or their derivatives allow the nematocidal effect of terpenes to be increased, while limiting the phytotoxic effect thereof.

According to a first object, the present invention relates to a method for the nematocidal treatment of plants, such as horticultural plants, especially fruits or vegetables, which comprises applying a composition comprising a combination of lecithin and/or derivative(s) thereof and one or more terpene(s) or a nutritionally acceptable salt thereof, or a mixture thereof, in an edible oil.

According to another object, the present invention relates also to the use of a combination comprising (a) lecithin(s) and/or derivative(s) thereof and (a) terpene(s) or a nutritionally acceptable salt thereof, or a mixture thereof, in an edible oil, in the nematocidal treatment of fruits or vegetables.

The amount of composition to be applied depends on the nature of the fruits or vegetables in question and on the chosen mode of application. In general, from 0.1 to 20 litres of terpene are applied per 1000 m² of soil surface.

The compositions according to the invention must be applied one or more times. According to an advantageous aspect, a single treatment is carried out.

The nematocidal treatment according to the invention is most particularly suitable for nematodes that attack the roots of the plants, such as the root-knot nematodes Meloidogyne spp.

It is aimed at all plants affected by these parasites, and especially horticultural plants. Horticultural plants are understood as being plants associated with market gardening, kitchen gardening, arboriculture and floriculture. The plants in question are especially cereals, fruits or vegetables such as the Solanaceae (tomato, aubergine, potato), the Cucurbitaceae (melon, cucumber), the Leguminosae (bean), carrot, scorzonera, lettuce, endive, artichoke, beet, celery, spinach, salad vegetables, radish, etc.

Terpenes are understood as being any terpene or any terpene-based essential oil, said terpene being selected especially from citral, pinene, nerol, b-ionone, geraniol, carvacrol, eugenol, carvone, terpineol, anethole, camphor, menthol, thymol, limonene, nerolidol, farnesol, linalool, phytol, p-menthane-1,8-diol, citronellol, carotene, and more principally terpenes having hydroxyl functional groups.

According to the invention, “terpene having a hydroxyl functional group” is understood as meaning terpenes having at least one hydroxyl, optionally phenol, functional group. The terpenes which can be used according to the invention preferably contain from 1 to 5, more preferably 1, 2 or 3, hydroxyl functional groups.

The terpenes used preferably have a steam pressure of at least 0.1 mm of mercury, more preferably from 0.1 mm to 5 mm of mercury.

As particularly preferred terpenes there may be mentioned eugenol, isoeugenol, nutritionally acceptable salts thereof and mixtures thereof.

It must be understood that, according to a more particularly preferred embodiment, there is used as active ingredient clove oil, which contains from 70% to 90% eugenol.

According to the invention, the expression “lecithins and/or derivatives thereof” is understood as meaning one or more compounds selected from the derivatives of phosphatidylcholine and/or derivatives thereof, such as phosphatidylcholine, phosphatidylinositol, phosphatidylethanolamine and/or phosphatidic acid, and/or mixtures thereof having two fatty acids, such as distearoyl, dipalmitoyl and/or dioleoyl phosphatidylcholine, phosphatidylinositol, phosphatidylethanolamine and/or phosphatidic acid, and/or mixtures thereof.

The “lecithins and/or derivatives thereof” are preferably of natural origin, such as, for example, derived from egg yolk or soybean.

According to an advantageous aspect, therefore, it is possible to use natural soybean lecithin comprising approximately one third soybean oil to approximately two thirds lecithin.

Conventionally, when they are employed as additives, such as, for example, emulsifying agents or surfactants, lecithins are generally present in low concentrations, such as from 1% to 5%. According to the invention, the lecithins can be present in the combinations according to the invention in an amount of up to 40% by weight.

The compositions according to the invention are advantageously formulated in an edible vegetable oil base. The oil base has been found to solubilise the treating compositions in a remarkable manner. It is possible especially to use any nutritionally acceptable oil, such as rapeseed oil, soybean oil, sunflower oil or arachis oil in particular.

According to the invention, “phytotoxicity” is understood as meaning any attack on the fruits and vegetables resulting from the direct action of the active ingredient, for example the terpenes, which manifests itself as a change in the visual appearance of said fruits and vegetables or their leaves.

According to the invention, “phytotoxicity” preferably denotes the direct alteration by said active ingredient of the integrity of the skin of said fruits and vegetables, especially by altering the colour or texture of their skin. More particularly, phytotoxicity can manifest itself as a homogeneous yellowish colouring, a reddish-brown pigmentation, the formation of yellow or brown stains or of punctual or extensive necrotic areas, or the formation of microlesions on, the skin.

Such microlesions then constitute an area that is favourable to moulds or to rotting of the fruits and vegetables.

According to the invention, said phytotoxicity defined hereinbefore results directly from the action of the active ingredient and consequently excludes natural ageing phenomena such as, especially, senescence.

The term “nematocide” denotes any treatment permitting the prevention of a future infestation or the eradication of an existing infestation of nematodes.

The following features or each of their combinations represent preferred embodiments of the method according to the invention:
said terpene(s) is (are) selected from eugenol, isoeugenol and clove oil, a nutritionally acceptable salt thereof or a mixture thereof;
said terpene(s) is (are) eugenol;
said composition is such that the weight ratio (soybean lecithin(s) and/or derivative(s) thereof/(terpene(s)) is from 0.5 to 5, preferably from 1.5 to 3;
said composition comprises an oil base;
said oil is rapeseed oil, sunflower oil or arachis oil;
said composition further comprises one or more surfactant(s);
said surfactant(s) is (are) selected from the non-ionic surfactants;
said surfactant(s) is (are) selected from the ethoxylated fatty acids;
said composition comprises, by weight:
   terpene(s): from 3 to 30%, preferably from 15 to 20%,
   lecithin(s) and/or derivative(s) thereof: from 1.5 to 40%, preferably from 7.5 to 30%,
   oil: qs;
said composition further comprises from 3 to 40% surfactant(s);
said method comprises applying from 0.1 to 20 litres of eugenol or clove oil, more preferably from 1 to 5 litres, per 1000 m² of soil surface;
said composition is applied by spraying, sprinkling or spreading;
said composition is applied one or more times during the period between sowing and ripening of the fruits or vegetables;
said composition is applied at ambient temperature.

The various surfactants or emulsifying agents are known per se. According to the present invention, “emulsifying agent” is understood as meaning any type of agent conventionally used for that purpose, such as ethoxylated fatty alcohols, ethoxylated fatty acids, ethoxylated alkylphenols or any other non-ionic product.

The surfactants preferably used within the scope of the invention are non-ionic surfactants.

Examples of non-ionic surfactants which can be used according to the invention are especially the condensation product of a preferably C₈-C₂₂ aliphatic fatty acid or alcohol with a C₂-C₃-alkylene oxide. The C₂-C₃-alkylene oxide can be ethylene oxide, propylene oxide, or a mixture of ethylene oxide and propylene oxide in any proportions. An example of such surfactants is the condensation product of oleic acid with 30 moles of ethylene oxide.

According to a particularly advantageous aspect, the surfactants can be selected according to their hydrophilicity. Accordingly, a more hydrophilic surfactant will be all the more suitable for dispersing the terpene(s); a less hydrophilic surfactant will be all the more suitable for dispersing the lecithin(s) and/or derivative(s) thereof and the oil base.

It may therefore be advantageous to formulate the components of said composition as follows:

Mixture a): the terpene(s) and at least one surfactant; and

Mixture b): the lecithin(s) and/or derivative(s) thereof, the edible vegetable oil.

Mixture b) can preferably comprise a second surfactant, said second surfactant being less hydrophilic than the surfactant of mixture a).

The treating compositions according to the invention can be prepared by homogenising mixtures a) and b) before said treating compositions are applied.

Said surfactant of mixture a) can advantageously be an ethoxylated fatty acid having from 7 to 15 moles of alkylene oxide.

Said surfactant of mixture b) can advantageously be an ethoxylated fatty acid having from 3 to 6 moles of alkylene oxide.

The present invention relates also to kits comprising mixtures a) and b) mentioned above.

Said kits preferably comprise:

Mixture a):
from 3 to 30% terpene(s);
from 2 to 30% of a surfactant;

Mixture b):
from 1 to 40% lecithin(s) and/or derivative(s) thereof;
edible vegetable oil base: qs.

According to an advantageous aspect, mixture b) can comprise a second surfactant, for example from 1 to 10% by weight.

The percentages indicated above are given by weight based on the total weight of the treating composition.

The emulsifying agents can also comprise other agents conventionally used in oils.

The invention is not limited to the use of these particular surfactants, however.

The percentages indicated hereinabove and hereinbelow are to be understood as being by weight based on the active ingredients. Because the active ingredients are available commercially in liquid form or in the form of a dilute solid, the amounts of these dilute forms must consequently be adjusted upwards.

For example, the “lecithin(s) and/or derivative(s) thereof” may be in diluted form in a powder comprising from 40% to 75% lecithin(s) and/or derivative(s) thereof. The indicated percentages are to be understood as being based on the undiluted “lecithin(s) and/or derivative(s) thereof”.

According to the invention, the lecithin(s) and/or derivative(s) thereof and the terpene(s) can be applied simultaneously, separately or spread over time. In the compositions according to the invention, the lecithin(s) and/or derivative(s) thereof can therefore be formulated on their own or in admixture with one or more terpene(s).

According to a preferred aspect, the “lecithin(s) and/or derivatives thereof” according to the invention include E322 lecithins or lecithins derived from soybean oil.

The treating compositions are prepared in the conventional manner by simply mixing their constituents.

However, the mixture of terpene(s) and lecithin(s) and/or derivative(s) thereof may be unstable. According to an advantageous aspect, the treating compositions according to the invention are prepared by mixing their components just before said compositions are applied.

According to another object, the present invention relates also to the use of a combination comprising (a) lecithin(s) and/or derivative(s) thereof and a terpene or a nutritionally acceptable salt thereof, or a mixture thereof, in the nematocidal treatment of fruits or vegetables.

The examples which follow are given by way of illustration and do not limit the present invention.

### EXAMPLE

The nematocidal activity of a formulation based on eugenol and soybean lecithin was evaluated on spinach and radish in a greenhouse as follows:

Technico-Agronomic Data of the Crop

| | |
|---|---|
| Species | Spinach (Spinacea oleracea) |
| | Radish (Raphanus sativum) |
| Crop | Spinach: Corenta (Royal Sluis) |
| | Radish: Wernar (S&G Syngenta) |
| Preceding crop | Tomato |
| Planting technique | Sowing in a greenhouse |
| Date of planting | 7 September |
| Pest | Root nematode (Meloidogyne spp.) |

Experimental Protocol

| | |
|---|---|
| Test plan | Fischer block, 4 repetitions |
| Number of tests | 5 |
| Size of the plot | 4 m × 3 m |
| Application equipment | Motor-driven pump equipped with a |
| | bar with TEEJET XR 110015 VS nozzles |
| | pressure 2.5 bar |
| | (boom sprayer) |
| Mode of application | Treatment over the entire area |
| Spray volume | 500 l/1000 m² |

Compared Evaluation of the Efficacy and Phytotoxicity of the Various Tests

| | |
|---|---|
| Efficacy | |
| Type of survey | Count of the plants affected by root |
| | galls (%) present in 20 cm of line of the 3 |
| | central lines of the m² taken as the sample |
| Dates | 15 Sept (T1 + 13); 5 Oct (T1 + 33) |
| Sample/plot area (m²) | 1 m² |
| Selectivity | |
| Type of survey | Phytotoxicity (scale 0-10) |
| | 0 no symptom, 10 plants destroyed |
| Dates | 15 Sept (T1 + 13); 5 Oct (T1 + 33) |
| Sample/plot area (m²) | 1 m² |
| Statistical analysis | Analysis of variance (ANOVA) and |
| | comparison of the differences between the |
| | means by the Duncan test at P ≦ 0.05 |

TABLE 1
Tests compared, rates of application

| | | | Rate of | |
|---|---|---|---|---|
| | | | application | |
| | | | (litre or kg of | |
| | | | commercial | Application |
| rt. | Product | Composition | formulation) | time |
| | Not treated | — | — | — |
| | XE-375-ML | eugenol (18%) | 5 l/1000 m² | at sowing |
| | XE-375-ML | eugenol (18%) | 10 l/1000 m² | at sowing |
| | ABT-EU04 | eugenol + soybean | 5 l/1000 m² | at sowing |
| | | lecithin (18% + 27%) | | |
| | ABT-EU04 | eugenol + soybean | 10 l/1000 m² | at sowing |
| | | lecithin (18% + 27%) | | |

Results

TABLE 2
Experimental results

| | | Nematocidal activity (1) | | | |
|---|---|---|---|---|---|
| | | Number of plants affected by nematodes | | | |
| | | (with root galls) % | | | |
| | | Spinach | | Radish | |
| | | 15-09 | 5-10 | 15-09 | 5-10 |
| rt. | Product | (T1 + 13) | (T1 + 33) | (T1 + 13) | (T1 + 33) |
| | Not treated | 78.2 a | 97.5 a | 95.5 a | 100 a |
| | XE-375-ML | 18.3 b | 44.7 b | 19.23 bc | 37.3 b |
| | XE-375-ML | 14.6 bc | 33.3 b | 8.7 c | 29.7 b |
| | ABT-EU04 | 7.7 c | 10.2 c | 4.6 cd | 8.5 c |
| | ABT-EU04 | 5.0 c | 9.2 c | 2.7 d | 6.6 c |
| | Transformation | None | None | Asin(Sqrt | None |
| | ANOVA | | | (x/100)) | |
| | <0.05 | | | | |

(1) The values marked with a different letter are differentiated significantly at P ≦ 0.05 (ANOVA - Duncan test).

TABLE 3
Crop selectivity

| | | Phytotoxicity - scale (0-10) and symptoms (1) | | | |
|---|---|---|---|---|---|
| | | Spinach | | Radish | |
| | | 15-09 | 5-10 | 15-09 | |
| Trt. | Product | (T1 + 13) | (T1 + 33) | (T1 + 13) | 5-10 (T1 + 33) |
| 1 | Not treated | 0 | 0 | 0 | 0 |
| 2 | XE-375-ML | 6.3 | 6.0 | 7.3 | 7.0 |
| 3 | XE-375-ML | 7.2 | 7.0 | 8.2 | 7.5 |
| 4 | ABT-EU04 | 0.7 | 0.4 | 1.0 | 0.5 |
| 5 | ABT-EU04 | 1.0 | 0.7 | 1.1 | 0.6 |

(1) Symptoms of phytotoxicity: necroses of the cotyledons, stoppage of growth, discolouration, change in the colour and shape of the leaves, death of the plant.

Analyses of the Results and Conclusions

The test was conducted on sandy soil which had not been chemically disinfected for about one year, with a large presence of gall-producing nematodes of Meloidogyne spp.

Spinach: treatment with ABT-EU04 carried out during sowing permitted about three times greater control of nematodes than did eugenol on its own and allowed the crop to reach harvest without delay under optimal conditions. No significant difference was observed between the tests treated with the two tested rates of application. The action of the product based on eugenol on its own (XE-375-ML) showed a slightly inferior control action, which was later reduced at the final check.

Product XE-375-ML caused serious damage to the spinach crop which, on the other hand, was well tolerant of the application of the product based on eugenol and soybean lecithin.

Radish: Product ABT-EU04 (eugenol+lecithin) was very effective in reducing the spread of nematode attacks at both rates of application. Likewise, as regards the radish crop, no significant difference was obtained with the higher dose of the test product.

With regard to crop selectivity, no symptom of phytotoxicity was observed on the crop following the treatments carried out during sowing using formulation ABT-EU04, whereas XE-375-ML caused serious and persistent damage to the radish plants.

Therefore, within the limits of the objectives of the study and taking into account the above conclusions, it is possible to state that the test formulation ABT-EU04 (eugenol+lecithin), when applied during sowing of spinach and radish, exhibited a pronounced action on the control of the spread of the gall-producing nematodes which was much better than that of eugenol on its own, without manifesting phytotoxicity to the crop.

Considering the composition of the two products tested, soybean lecithin has an action fundamental to improving the efficacy of the control of nematodes and for the control of the phytotoxic action of eugenol.

Kit According to the Invention

A treating composition according to the invention is prepared as follows:
Preparation of mixture a):

18 g of clove oil and 16 g of 10 mol ethoxylated acid are mixed.
Preparation of mixture b):

42 g of natural soybean lecithin and 4 g of 6 mol ethoxylated fatty acid in 20 g of sunflower oil are mixed.

Mixing and homogenisation are carried out, then the composition so obtained is applied.

1-22. (canceled)

23. A method for the nematocidal treatment of horticultural plants, which comprises applying a composition comprising a combination of lecithin(s) and/or derivatives thereof and one or more terpene(s) or a nutritionally acceptable salt thereof, or a mixture thereof, in an edible vegetable oil.

24. The method according to claim 23, such that said terpene(s) is (are) selected from eugenol, isoeugenol and clove oil, a nutritionally acceptable salt thereof or a mixture thereof.

25. The method according to claim 23, such that said terpene(s) is (are) eugenol.

26. The method according to claim 23, such that said composition is such that the weight ratio (lecithin(s) and/or derivative(s) thereof/(terpene(s)) is from 0.5 to 5.

27. The method according to claim 23, such that said oil is rapeseed oil.

28. The method according to claim 23, such that said composition further comprises one or more surfactant(s).

29. The method according to claim 28, such that said surfactant(s) is (are) selected from the non-ionic surfactants.

30. The method according to claim 28, such that said surfactant(s) is (are) selected from the ethoxylated fatty acids.

31. The method according to claim 23, such that said composition comprises, by weight:
terpene(s): from 3 to 30%,
lecithin(s) and/or derivative(s) thereof: from 1.5 to 40%,
oil: qs.

32. The method according to claim 23, such that said composition further comprises from 3 to 40% by weight surfactant(s).

33. The method according to claim 23, which comprises applying from 0.1 to 20 litres of eugenol or clove oil per 1000 m² of soil surface.

34. The method according to claim 23, such that the composition is applied by spraying, sprinkling or spreading.

35. The method according to claim 23, such that the nematodes in question are selected from the gall-forming nematodes.

36. The method according to claim 23, such that the composition is applied one or more times during the period between sowing and ripening of the plants.

37. The method according to claim 23, such that the horticultural plants are selected from fruits and vegetables.

38. A method of nematocidal treatment of horticultural plants comprising applying a combination comprising (a) lecithin(s) and/or derivative(s) thereof and (b) a terpene or a nutritionally acceptable salt thereof, or a mixture thereof, on the plants.

39. A kit comprising:
mixture a): the terpene(s) and at least one surfactant; and
mixture b): the lecithin(s) and/or derivative(s) thereof, the edible vegetable oil base, as defined according to claim 23.

40. The kit according to claim 39, such that mixture b) comprises a second surfactant, said surfactant of mixture a) being more hydrophilic than the surfactant of mixture b).

41. The kit according to claim 39, such that said surfactant of mixture a) is an ethoxylated fatty acid having from 7 to 15 moles of alkylene oxide.

42. The kit according to claim 40, such that said surfactant of mixture b) is an ethoxylated fatty acid having from 3 to 6 moles of alkylene oxide.

43. The kit according to claim 39, comprising:
i) mixture a):
from 3 to 30% terpene(s);
from 2 to 30% of said first surfactant;
ii) mixture b):
from 1 to 40% lecithin(s) and/or derivative(s) thereof;
oil base: qs,
the indicated percentages being based on the total weight of the treating composition.

44. The kit according to claim 43, such that mixture b) comprises from 1% to 10% surfactant.
